(19) United States
(12) Patent Application Publication
(10) Pub. No.: US 2012/0216020 A1
(43) Pub. Date: Aug. 23, 2012

(54) INSTRUCTION SUPPORT FOR PERFORMING STREAM CIPHER

(76) Inventors: Christopher H. Olson, Austin, TX (US); Gregory F. Grohoski, Bee Cave, TX (US); Manish K. Shah, Austin, TX (US)

(21) Appl. No.: 13/031,571

(22) Filed: Feb. 21, 2011

(51) Int. Cl. G06F 9/30

(52) U.S. Cl. 712/205; 712/E09.016

(57) ABSTRACT

Techniques relating to a processor that provides instruction-level support for a stream cipher are disclosed. In one embodiment, the processor supports a first instruction executable to perform an alpha multiplication, an alpha division, and an exclusive-OR operation using a result of the alpha multiplication and a result of the alpha division. In one embodiment, the processor supports a second instruction executable to perform a modular addition of a value R1 and a value S, and to perform a first exclusive-OR operation on a result of the modular addition and a value R2. In one embodiment, the processor supports a third instruction executable to perform a substitution-box (S-Box) operation on a value R1 to produce a value R2′, and to perform a modular addition using a value R2 to produce a value R1'.

### BACKGROUND

1. Technical Field

This disclosure relates to processors, and more specifically to implementation of cryptographic algorithms.

2. Description of the Related Art

Securing transactions and communications against tampering, interception and unauthorized use has become a problem of increasing significance as new forms of electronic commerce and communication proliferate. To provide a measure of security for sensitive data, various cryptographic algorithms have been developed to encrypt sensitive information transmitted over an insecure channel. As computer performance has improved (e.g., due to development of faster processors), less sophisticated cryptographic algorithms are more likely to become compromised. More complex algorithms, however, can require greater overhead to implement.

Stream ciphers, such as the Snow cipher, have become popular because, in many instances, they use less overhead to encrypt information than block ciphers. Typically, plaintext may be encrypted by merely performing an exclusive-OR (XOR) operation of the plaintext and bytes of a generated cipher key. Generating a cipher key can still be computationally intensive in some instances.

### SUMMARY

Structures and methods are disclosed herein that allow a processor to provide instruction-level support for a stream cipher. In one embodiment, a processor is disclosed that includes an instruction fetch unit configured to fetch instructions defined in an instruction set architecture (ISA) and executable by the processor. The processor further includes an instruction execution unit configured to receive instructions fetched by the instruction fetch unit. The received instructions include an instance of a first instruction defined within the ISA. The first instruction is executable by the processor to perform an alpha multiplication, an alpha division, and a first exclusive-OR operation using a result of the alpha multiplication and a result of the alpha division.

In another embodiment, a processor is disclosed that includes an instruction fetch unit configured to fetch instructions defined in an instruction set architecture (ISA) and executable by the processor. The processor further includes an instruction execution unit configured to receive instructions fetched by the instruction fetch unit. The received instructions include an instance of a first instruction defined within the ISA. The first instruction is executable by the processor to perform a modular addition of a value R1 and a value S, and to perform a first exclusive-OR operation on a result of the modular addition and a value R2. In such an embodiment, the value R2 is a result of a substitution-box (S-Box) operation.

In yet another embodiment, a processor is disclosed that includes an instruction fetch unit configured to fetch instructions defined in an instruction set architecture (ISA) and executable by the processor. The processor further includes an instruction execution unit configured to receive instructions fetched by the instruction fetch unit. The received instructions include an instance of a first instruction defined within the ISA. The instruction is executable by the processor to perform a substitution-box (S-Box) operation on a value R1 to produce a value R2′, and to perform a modular addition using a value R2 to produce a value R1′.

### BRIEF DESCRIPTION OF THE DRAWINGS

FIG. 1 is a block diagram illustrating one embodiment of an exemplary processor.

FIG. 2 is a block diagram illustrating one embodiment of an exemplary processor core.

FIG. 3 is a block diagram illustrating one embodiment of a floating-point graphics unit that includes a cryptographic unit configured to implement a stream-cipher algorithm.

FIGS. 4A and 4B are block diagrams illustrating one embodiment of a Snow cipher algorithm.

FIG. 5 is a block diagram illustrating one embodiment of a Snow engine configured to implement a Snow cipher.

FIGS. 6A-C are flow diagrams illustrating embodiments of methods for executing instructions that perform operations of a Snow cipher.

FIG. 7 is a flow diagram illustrating one embodiment of a method for performing a round of a Snow cipher.

FIG. 8 is a flow diagram illustrating one embodiment of a method for initializing a Snow cipher.

FIG. 9 is a block diagram illustrating one embodiment of an exemplary system that may include the processor.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component.

“First,” “Second,” etc. As used herein, these terms are used as labels for nouns that they precede, and do not imply any type of ordering (e.g., spatial, temporal, logical, etc.). For example, in a processor having eight processing elements or cores, the terms “first” and “second” processing elements can be used to refer to any two of the eight processing elements. In other words, the “first” and “second” processing elements are not limited to logical processing elements 0 and 1.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Execute.” This term has its ordinary and accepted meaning in the art, and includes all actions that may be performed by a processor to effectuate the completion of the instruction, including fetch, decode, issue, as well as actually computing the result of the instruction. When a functional unit is described herein as “executing” a particular instruction, this term refers to computing a result of the particular instruction (e.g., computing the sum of the contents of two registers).

### Introduction

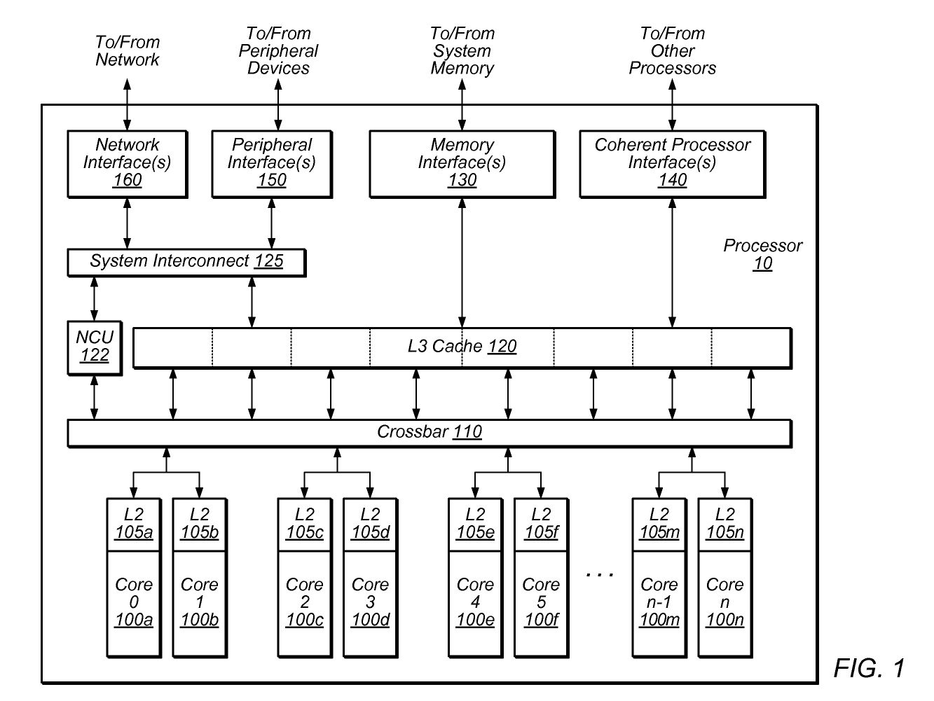

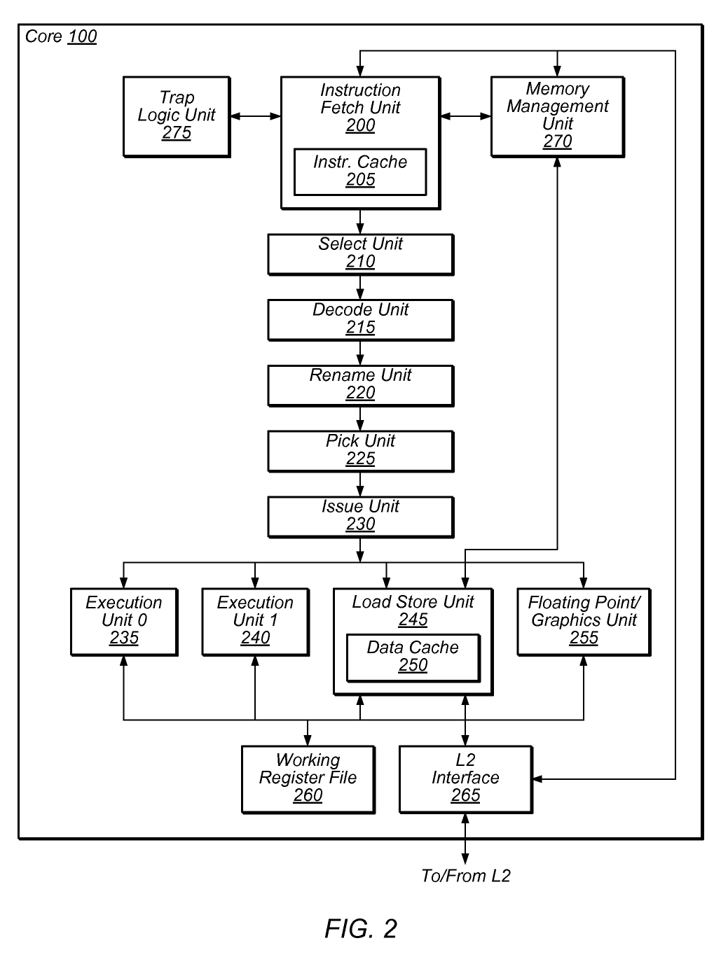

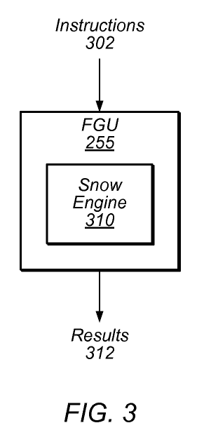

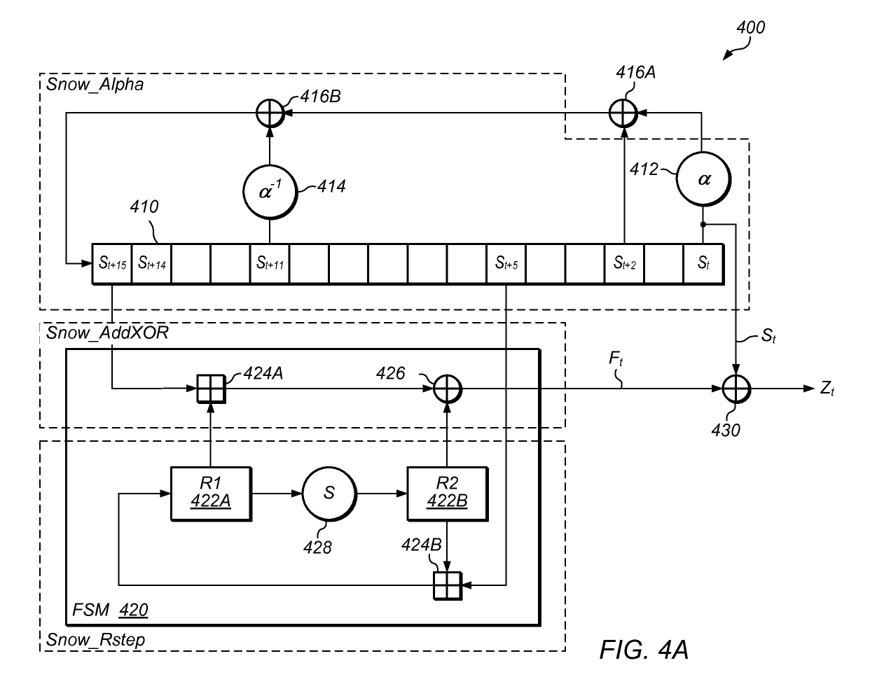

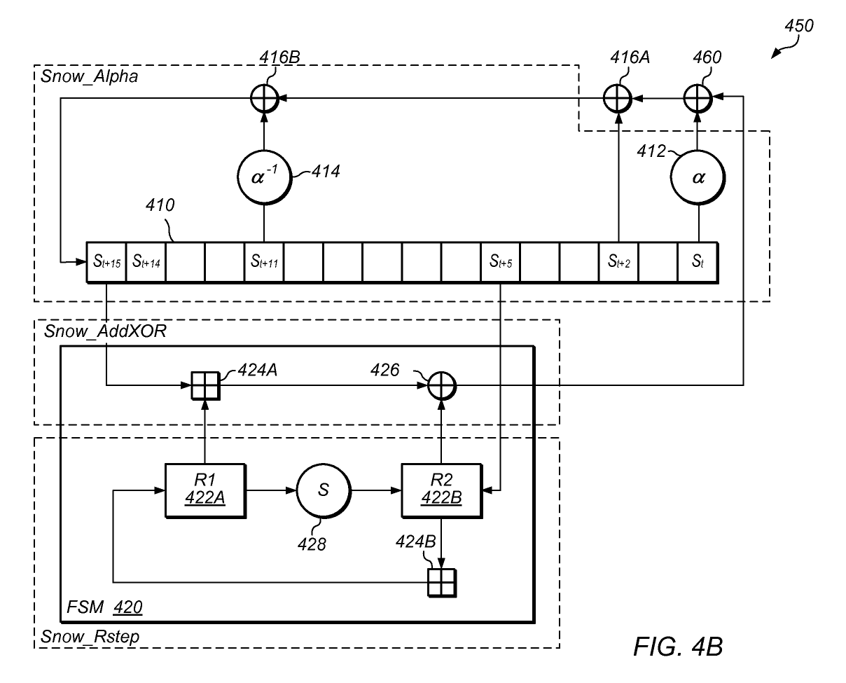

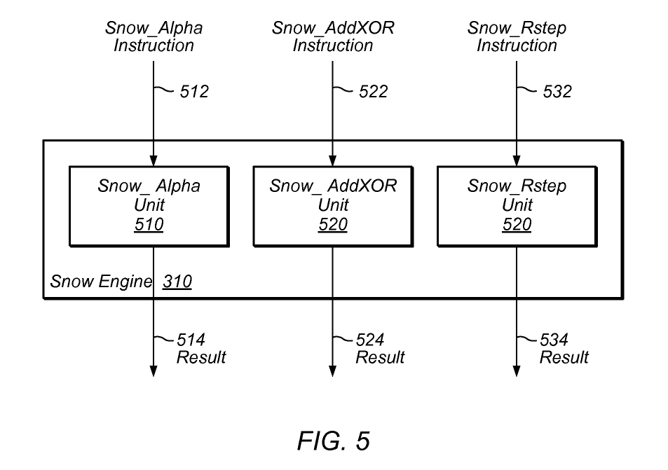

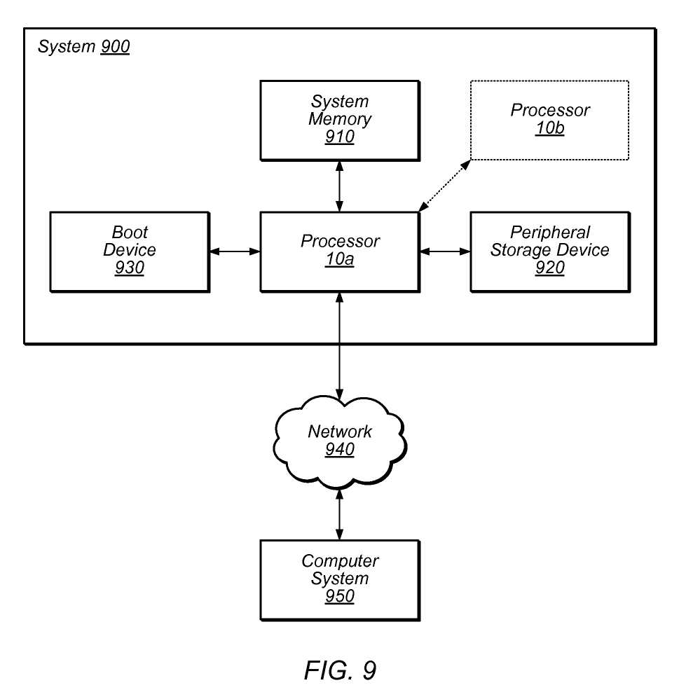

The present disclosure describes various techniques for providing instruction-level support for a stream cipher algorithm. FIGS. 1 and 2 present an overview of an exemplary multithreaded processor. FIG. 3 presents an embodiment of a Snow engine configured to perform operations for a Snow cipher. FIGS. 4A and 4B present an overview of one version of the Snow cipher algorithm that may be supported by the Snow engine. FIG. 5 presents embodiments of units included in the Snow engine that are configured to perform instructions supported by the processor. FIGS. 6-8 present embodiments of methods that may be performed by the processor. FIG. 9 presents an overview of a computer system in which the processor may be used.

### General Overview of Multithreaded Processor

Turning now to FIG. 1, a block diagram illustrating one embodiment of a processor 10 is shown. In certain embodiments, processor 10 may be multithreaded. In the illustrated embodiment, processor 10 includes a number of processor cores 100a-n, which are also designated “core 0” though “core n.” As used herein, the term processor may refer to an apparatus having a single processor core or an apparatus that includes two or more processor cores. Various embodiments of processor 10 may include varying numbers of cores 100, such as 8, 16, or any other suitable number. Each of cores 100 is coupled to a corresponding L2 cache 105a-n, which in turn couple to L3 cache 120 via a crossbar 110. Cores 100a-n and L2 caches 105a-n may be generically referred to, either collectively or individually, as core(s) 100 and L2 cache(s) 105, respectively.

Via crossbar 110 and L3 cache 120, cores 100 may be coupled to a variety of devices that may be located externally to processor 10. In the illustrated embodiment, one or more memory interface(s) 130 may be configured to couple to one or more banks of system memory (not shown). One or more coherent processor interface(s) 140 may be configured to couple processor 10 to other processors (e.g., in a multiprocessor environment employing multiple units of processor 10). Additionally, system interconnect 125 couples cores 100 to one or more peripheral interface(s) 150 and network interface(s) 160. As described in greater detail below, these interfaces may be configured to couple processor 10 to various peripheral devices and networks.

Cores 100 may be configured to execute instructions and to process data according to a particular instruction set architecture (ISA). In one embodiment, cores 100 may be configured to implement a version of the SPARC® ISA, such as SPARC® V9, UltraSPARC Architecture 2005, UltraSPARC Architecture 2007, or UltraSPARC Architecture 2009, for example. However, in other embodiments it is contemplated that any desired ISA may be employed, such as x86 (32-bit or 64-bit versions), PowerPC® or MIPS®, for example.

In the illustrated embodiment, each of cores 100 may be configured to operate independently of the others, such that all cores 100 may execute in parallel (i.e., concurrently). Additionally, as described below in conjunction with the descriptions of FIG. 2, in some embodiments, each of cores 100 may be configured to execute multiple threads concurrently, where a given thread may include a set of instructions that may execute independently of instructions from another thread. (For example, an individual software process, such as an application, may consist of one or more threads that may be scheduled for execution by an operating system.) Such a core 100 may also be referred to as a multithreaded (MT) core. In one embodiment, each of cores 100 may be configured to concurrently execute instructions from a variable number of threads, up to eight concurrently-executing threads. In a 16-core implementation, processor 10 could thus concurrently execute up to 128 threads. However, in other embodiments it is contemplated that other numbers of cores 100 may be provided, and that cores 100 may concurrently process different numbers of threads.

Additionally, as described in greater detail below, in some embodiments, each of cores 100 may be configured to execute certain instructions out of program order, which may also be referred to herein as out-of-order execution, or simply OOO. As an example of out-of-order execution, for a particular thread, there may be instructions that are subsequent in program order to a given instruction yet do not depend on the given instruction. If execution of the given instruction is delayed for some reason (e.g., owing to a cache miss), the later instructions may execute before the given instruction completes, which may improve overall performance of the executing thread.

As shown in FIG. 1, in one embodiment, each core 100 may have a dedicated corresponding L2 cache 105. In one embodiment, L2 cache 105 may be configured as a set-associative, write-back cache that is fully inclusive of first-level cache state (e.g., instruction and data caches within core 100). To maintain coherence with first-level caches, embodiments of L2 cache 105 may implement a reverse directory that maintains a virtual copy of the first-level cache tags. L2 cache 105 may implement a coherence protocol (e.g., the MESI protocol) to maintain coherence with other caches within processor 10. In one embodiment, L2 cache 105 may enforce a Total Store Ordering (TSO) model of execution in which all store instructions from the same thread must complete in program order.

In various embodiments, L2 cache 105 may include a variety of structures configured to support cache functionality and performance. For example, L2 cache 105 may include a miss buffer configured to store requests that miss the L2, a fill buffer configured to temporarily store data returning from L3 cache 120, a write-back buffer configured to temporarily store dirty evicted data and snoop copyback data, and/or a snoop buffer configured to store snoop requests received from L3 cache 120. In one embodiment, L2 cache 105 may implement a history-based prefetcher that may attempt to analyze L2 miss behavior and correspondingly generate prefetch requests to L3 cache 120.

Crossbar 110 may be configured to manage data flow between L2 caches 105 and the shared L3 cache 120. In one embodiment, crossbar 110 may include logic (such as multiplexers or a switch fabric, for example) that allows any L2 cache 105 to access any bank of L3 cache 120, and that conversely allows data to be returned from any L3 bank to any L2 cache 105. That is, crossbar 110 may be configured as an M-to-N crossbar that allows for generalized point-to-point communication. However, in other embodiments, other interconnection schemes may be employed between L2 caches 105 and L3 cache 120. For example, a mesh, ring, or other suitable topology may be utilized.

Crossbar 110 may be configured to concurrently process data requests from L2 caches 105 to L3 cache 120 as well as data responses from L3 cache 120 to L2 caches 105. In some embodiments, crossbar 110 may include logic to queue data requests and/or responses, such that requests and responses may not block other activity while waiting for service. Additionally, in one embodiment crossbar 110 may be configured to arbitrate conflicts that may occur when multiple L2 caches 105 attempt to access a single bank of L3 cache 120, or vice versa.

L3 cache 120 may be configured to cache instructions and data for use by cores 100. In the illustrated embodiment, L3 cache 120 may be organized into eight separately addressable banks that may each be independently accessed, such that in the absence of conflicts, each bank may concurrently return data to a respective L2 cache 105. In some embodiments, each individual bank may be implemented using set-associative or direct-mapped techniques. For example, in one embodiment, L3 cache 120 may be an 8 megabyte (MB) cache, where each 1 MB bank is 16-way set associative with a 64-byte line size. L3 cache 120 may be implemented in some embodiments as a write-back cache in which written (dirty) data may not be written to system memory until a corresponding cache line is evicted. However, it is contemplated that in other embodiments, L3 cache 120 may be configured in any suitable fashion. For example, L3 cache 120 may be implemented with more or fewer banks, or in a scheme that does not employ independently-accessible banks; it may employ other bank sizes or cache geometries (e.g., different line sizes or degrees of set associativity); it may employ write through instead of write-back behavior; and it may or may not allocate on a write miss. Other variations of L3 cache 120 configuration are possible and contemplated.

In some embodiments, L3 cache 120 may implement queues for requests arriving from and results to be sent to crossbar 110. Additionally, in some embodiments L3 cache 120 may implement a fill buffer configured to store fill data arriving from memory interface 130, a write-back buffer configured to store dirty evicted data to be written to memory, and/or a miss buffer configured to store L3 cache accesses that cannot be processed as simple cache hits (e.g., L3 cache misses, cache accesses matching older misses, accesses such as atomic operations that may require multiple cache accesses, etc.). L3 cache 120 may variously be implemented as single-ported or multiported (i.e., capable of processing multiple concurrent read and/or write accesses). In either case, L3 cache 120 may implement arbitration logic to prioritize cache access among various cache read and write requestors.

Not all external accesses from cores 100 necessarily proceed through L3 cache 120. In the illustrated embodiment, non-cacheable unit (NCU) 122 may be configured to process requests from cores 100 for non-cacheable data, such as data from I/O devices as described below with respect to peripheral interface(s) 150 and network interface(s) 160.

Memory interface 130 may be configured to manage the transfer of data between L3 cache 120 and system memory, for example in response to cache fill requests and data evictions. In some embodiments, multiple instances of memory interface 130 may be implemented, with each instance configured to control a respective bank of system memory. Memory interface 130 may be configured to interface to any suitable type of system memory, such as Fully Buffered Dual Inline Memory Module (FB-DIMM), Double Data Rate or Double Data Rate 2, 3, or 4 Synchronous Dynamic Random Access Memory (DDR/DDR2/DDR3/DDR4 SDRAM), or Rambus® DRAM (RDRAM®), for example. In some embodiments, memory interface 130 may be configured to support interfacing to multiple different types of system memory.

In the illustrated embodiment, processor 10 may also be configured to receive data from sources other than system memory. System interconnect 125 may be configured to provide a central interface for such sources to exchange data with cores 100, L2 caches 105, and/or L3 cache 120. In some embodiments, system interconnect 125 may be configured to coordinate Direct Memory Access (DMA) transfers of data to and from system memory. For example, via memory interface 130, system interconnect 125 may coordinate DMA transfers between system memory and a network device attached via network interface 160, or between system memory and a peripheral device attached via peripheral interface 150.

Processor 10 may be configured for use in a multiprocessor environment with other instances of processor 10 or other compatible processors. In the illustrated embodiment, coherent processor interface(s) 140 may be configured to implement high-bandwidth, direct chip-to-chip communication between different processors in a manner that preserves memory coherence among the various processors (e.g., according to a coherence protocol that governs memory transactions).

Peripheral interface 150 may be configured to coordinate data transfer between processor 10 and one or more peripheral devices. Such peripheral devices may include, for example and without limitation, storage devices (e.g., magnetic or optical media-based storage devices including hard drives, tape drives, CD drives, DVD drives, etc.), display devices (e.g., graphics subsystems), multimedia devices (e.g., audio processing subsystems), or any other suitable type of peripheral device. In one embodiment, peripheral interface 150 may implement one or more instances of a standard peripheral interface. For example, one embodiment of peripheral interface 150 may implement the Peripheral Component Interface Express (PCI Express™ or PCIe) standard according to generation 1.x, 2.0, 3.0, or another suitable variant of that standard, with any suitable number of I/O lanes. However, it is contemplated that any suitable interface standard or combination of standards may be employed. For example, in some embodiments peripheral interface 150 may be configured to implement a version of Universal Serial Bus (USB) protocol or IEEE 1394 (Firewire®) protocol in addition to or instead of PCI Express™.

Network interface 160 may be configured to coordinate data transfer between processor 10 and one or more network devices (e.g., networked computer systems or peripherals) coupled to processor 10 via a network. In one embodiment, network interface 160 may be configured to perform the data processing necessary to implement an Ethernet (IEEE 802.3) networking standard such as Gigabit Ethernet or 10-Gigabit Ethernet, for example. However, it is contemplated that any suitable networking standard may be implemented, including forthcoming standards such as 40-Gigabit Ethernet and 100-Gigabit Ethernet. In some embodiments, network interface 160 may be configured to implement other types of networking protocols, such as Fibre Channel, Fibre Channel over Ethernet (FCoE), Data Center Ethernet, Infiniband, and/or other suitable networking protocols. In some embodiments, network interface 160 may be configured to implement multiple discrete network interface ports.

### Overview of Dynamic Multithreading Processor Core

As mentioned above, in one embodiment each of cores 100 may be configured for multithreaded, out-of-order execution. More specifically, in one embodiment, each of cores 100 may be configured to perform dynamic multithreading. Generally speaking, under dynamic multithreading, the execution resources of cores 100 may be configured to efficiently process varying types of computational workloads that exhibit different performance characteristics and resource requirements. Such workloads may vary across a continuum that emphasizes different combinations of individual-thread and multiple-thread performance.

At one end of the continuum, a computational workload may include a number of independent tasks, where completing the aggregate set of tasks within certain performance criteria (e.g., an overall number of tasks per second) is a more significant factor in system performance than the rate at which any particular task is completed. For example, in certain types of server or transaction processing environments, there may be a high volume of individual client or customer requests (such as web page requests or file system accesses). In this context, individual requests may not be particularly sensitive to processor performance. For example, requests may be I/O-bound rather than processor-bound—completion of an individual request may require I/O accesses (e.g., to relatively slow memory, network, or storage devices) that dominate the overall time required to complete the request, relative to the processor effort involved. Thus, a processor that is capable of concurrently processing many such tasks (e.g., as independently executing threads) may exhibit better performance on such a workload than a processor that emphasizes the performance of only one or a small number of concurrent tasks.

At the other end of the continuum, a computational workload may include individual tasks whose performance is highly processor-sensitive. For example, a task that involves significant mathematical analysis and/or transformation (e.g., cryptography, graphics processing, scientific computing) may be more processor-bound than I/O-bound. Such tasks may benefit from processors that emphasize single-task performance, for example through speculative execution and exploitation of instruction-level parallelism.

Dynamic multithreading represents an attempt to allocate processor resources in a manner that flexibly adapts to workloads that vary along the continuum described above. In one embodiment, cores 100 may be configured to implement fine-grained multithreading, in which each core may select instructions to execute from among a pool of instructions corresponding to multiple threads, such that instructions from different threads may be scheduled to execute adjacently. For example, in a pipelined embodiment of core 100 employing fine-grained multithreading, instructions from different threads may occupy adjacent pipeline stages, such that instructions from several threads may be in various stages of execution during a given core processing cycle. Through the use of fine-grained multithreading, cores 100 may be configured to efficiently process workloads that depend more on concurrent thread processing than individual thread performance.

In one embodiment, cores 100 may also be configured to implement out-of-order processing, speculative execution, register renaming and/or other features that improve the performance of processor-dependent workloads. Moreover, cores 100 may be configured to dynamically allocate a variety of hardware resources among the threads that are actively executing at a given time, such that if fewer threads are executing, each individual thread may be able to take advantage of a greater share of the available hardware resources. This may result in increased individual thread performance when fewer threads are executing, while retaining the flexibility to support workloads that exhibit a greater number of threads that are less processor-dependent in their performance. In various embodiments, the resources of a given core 100 that may be dynamically allocated among a varying number of threads may include branch resources (e.g., branch predictor structures), load/store resources (e.g., load/store buffers and queues), instruction completion resources (e.g., reorder buffer structures and commit logic), instruction issue resources (e.g., instruction selection and scheduling structures), register rename resources (e.g., register mapping tables), and/or memory management unit resources (e.g., translation lookaside buffers, page walk resources).

One embodiment of core 100 that is configured to perform dynamic multithreading is illustrated in FIG. 2. In the illustrated embodiment, core 100 includes an instruction fetch unit (IFU) 200 that includes an instruction cache 205. IFU 200 is coupled to a memory management unit (MMU) 270, L2 interface 265, and trap logic unit (TLU) 275. IFU 200 is additionally coupled to an instruction processing pipeline that begins with a select unit 210 and proceeds in turn through a decode unit 215, a rename unit 220, a pick unit 225, and an issue unit 230. Issue unit 230 is coupled to issue instructions to any of a number of instruction execution resources: an execution unit 0 (EXU0) 235, an execution unit 1 (EXU1) 240, a load store unit (LSU) 245 that includes a data cache 250, and/or a floating-point/graphics unit (FGU) 255. These instruction execution resources are coupled to a working register file 260. Additionally, LSU 245 is coupled to L2 interface 265 and MMU 270.

In the following discussion, exemplary embodiments of each of the structures of the illustrated embodiment of core 100 are described. However, it is noted that the illustrated partitioning of resources is merely one example of how core 100 may be implemented. Alternative configurations and variations are possible and contemplated.

Instruction fetch unit 200 may be configured to provide instructions to the rest of core 100 for execution. In one embodiment, IFU 200 may be configured to select a thread to be fetched, fetch instructions from instruction cache 205 for the selected thread and buffer them for downstream processing, request data from L2 cache 105 in response to instruction cache misses, and predict the direction and target of control transfer instructions (e.g., branches). In some embodiments, IFU 200 may include a number of data structures in addition to instruction cache 205, such as an instruction translation lookaside buffer (ITLB), instruction buffers, and/or structures configured to store state that is relevant to thread selection and processing.

In one embodiment, during each execution cycle of core 100, IFU 200 may be configured to select one thread that will enter the IFU processing pipeline. Thread selection may take into account a variety of factors and conditions, some thread-specific and others IFU-specific. For example, certain instruction cache activities (e.g., cache fill), ITLB activities, or diagnostic activities may inhibit thread selection if these activities are occurring during a given execution cycle. Additionally, individual threads may be in specific states of readiness that affect their eligibility for selection. For example, a thread for which there is an outstanding instruction cache miss may not be eligible for selection until the miss is resolved. In some embodiments, those threads that are eligible to participate in thread selection may be divided into groups by priority, for example depending on the state of the thread or of the ability of the IFU pipeline to process the thread. In such embodiments, multiple levels of arbitration may be employed to perform thread selection: selection occurs first by group priority, and then within the selected group according to a suitable arbitration algorithm (e.g., a least-recently-fetched algorithm). However, it is noted that any suitable scheme for thread selection may be employed, including arbitration schemes that are more complex or simpler than those mentioned here.

Once a thread has been selected for fetching by IFU 200, instructions may actually be fetched for the selected thread. To perform the fetch, in one embodiment, IFU 200 may be configured to generate a fetch address to be supplied to instruction cache 205. In various embodiments, the fetch address may be generated as a function of a program counter associated with the selected thread, a predicted branch target address, or an address supplied in some other manner (e.g., through a test or diagnostic mode). The generated fetch address may then be applied to instruction cache 205 to determine whether there is a cache hit.

In some embodiments, accessing instruction cache 205 may include performing fetch address translation (e.g., in the case of a physically indexed and/or tagged cache), accessing a cache tag array, and comparing a retrieved cache tag to a requested tag to determine cache hit status. If there is a cache hit, IFU 200 may store the retrieved instructions within buffers for use by later stages of the instruction pipeline. If there is a cache miss, IFU 200 may coordinate retrieval of the missing cache data from L2 cache 105. In some embodiments, IFU 200 may also be configured to prefetch instructions into instruction cache 205 before the instructions are actually required to be fetched. For example, in the case of a cache miss, IFU 200 may be configured to retrieve the missing data for the requested fetch address as well as addresses that sequentially follow the requested fetch address, on the assumption that the following addresses are likely to be fetched in the near future.

In many ISAs, instruction execution proceeds sequentially according to instruction addresses (e.g., as reflected by one or more program counters). However, control transfer instructions (CTIs) such as branches, call/return instructions, or other types of instructions may cause the transfer of execution from a current fetch address to a nonsequential address. As mentioned above, IFU 200 may be configured to predict the direction and target of CTIs (or, in some embodiments, a subset of the CTIs that are defined for an ISA) in order to reduce the delays incurred by waiting until the effect of a CTI is known with certainty. In one embodiment, IFU 200 may be configured to implement a perceptron-based dynamic branch predictor, although any suitable type of branch predictor may be employed.

To implement branch prediction, IFU 200 may implement a variety of control and data structures in various embodiments, such as history registers that track prior branch history, weight tables that reflect relative weights or strengths of predictions, and/or target data structures that store fetch addresses that are predicted to be targets of a CTI. Also, in some embodiments, IFU 200 may further be configured to partially decode (or predecode) fetched instructions in order to facilitate branch prediction. A predicted fetch address for a given thread may be used as the fetch address when the given thread is selected for fetching by IFU 200. The outcome of the prediction may be validated when the CTI is actually executed (e.g., if the CTI is a conditional instruction, or if the CTI itself is in the path of another predicted CTI). If the prediction was incorrect, instructions along the predicted path that were fetched and issued may be cancelled.

Through the operations discussed above, IFU 200 may be configured to fetch and maintain a buffered pool of instructions from one or multiple threads, to be fed into the remainder of the instruction pipeline for execution. Generally speaking, select unit 210 may be configured to select and schedule threads for execution. In one embodiment, during any given execution cycle of core 100, select unit 210 may be configured to select up to one ready thread out of the maximum number of threads concurrently supported by core 100 (e.g., 8 threads), and may select up to two instructions from the selected thread for decoding by decode unit 215, although in other embodiments, a differing number of threads and instructions may be selected. In various embodiments, different conditions may affect whether a thread is ready for selection by select unit 210, such as branch mispredictions, unavailable instructions, or other conditions. To ensure fairness in thread selection, some embodiments of select unit 210 may employ arbitration among ready threads (e.g. a least-recently-used algorithm).

The particular instructions that are selected for decode by select unit 210 may be subject to the decode restrictions of decode unit 215; thus, in any given cycle, fewer than the maximum possible number of instructions may be selected. Additionally, in some embodiments, select unit 210 may be configured to allocate certain execution resources of core 100 to the selected instructions, so that the allocated resources will not be used for the benefit of another instruction until they are released. For example, select unit 210 may allocate resource tags for entries of a reorder buffer, load/store buffers, or other downstream resources that may be utilized during instruction execution.

Generally, decode unit 215 may be configured to prepare the instructions selected by select unit 210 for further processing. Decode unit 215 may be configured to identify the particular nature of an instruction (e.g., as specified by its opcode) and to determine the source and sink (i.e., destination) registers encoded in an instruction, if any. In some embodiments, decode unit 215 may be configured to detect certain dependencies among instructions, to remap architectural registers to a flat register space, and/or to convert certain complex instructions to two or more simpler instructions for execution. Additionally, in some embodiments, decode unit 215 may be configured to assign instructions to slots for subsequent scheduling. In one embodiment, two slots 0-1 may be defined, where slot 0 includes instructions executable in load/store unit 245 or execution units 235-240, and where slot 1 includes instructions executable in execution units 235-240, floating-point/graphics unit 255, and any branch instructions. However, in other embodiments, other numbers of slots and types of slot assignments may be employed, or slots may be omitted entirely.

Register renaming may facilitate the elimination of certain dependencies between instructions (e.g., write-after-read or “false” dependencies), which may in turn prevent unnecessary serialization of instruction execution. In one embodiment, rename unit 220 may be configured to rename the logical (i.e., architected) destination registers specified by instructions by mapping them to a physical register space, resolving false dependencies in the process. In some embodiments, rename unit 220 may maintain mapping tables that reflect the relationship between logical registers and the physical registers to which they are mapped.

Once decoded and renamed, instructions may be ready to be scheduled for execution. In the illustrated embodiment, pick unit 225 may be configured to pick instructions that are ready for execution and send the picked instructions to issue unit 230. In one embodiment, pick unit 225 may be configured to maintain a pick queue that stores a number of decoded and renamed instructions as well as information about the relative age and status of the stored instructions. During each execution cycle, this embodiment of pick unit 225 may pick up to one instruction per slot. For example, taking instruction dependency and age information into account, for a given slot, pick unit 225 may be configured to pick the oldest instruction for the given slot that is ready to execute.

In some embodiments, pick unit 225 may be configured to support load/store speculation by retaining speculative load/store instructions (and, in some instances, their dependent instructions) after they have been picked. This may facilitate replaying of instructions in the event of load/store misspeculation. Additionally, in some embodiments, pick unit 225 may be configured to deliberately insert “holes” into the pipeline through the use of stalls, e.g., in order to manage downstream pipeline hazards such as synchronization of certain load/store or long-latency FGU instructions.

Issue unit 230 may be configured to provide instruction sources and data to the various execution units for picked instructions. In one embodiment, issue unit 230 may be configured to read source operands from the appropriate source, which may vary depending upon the state of the pipeline. For example, if a source operand depends on a prior instruction that is still in the execution pipeline, the operand may be bypassed directly from the appropriate execution unit result bus. Results may also be sourced from register files representing architectural (i.e., user-visible) as well as non-architectural state. In the illustrated embodiment, core 100 includes a working register file 260 that may be configured to store instruction results (e.g., integer results, floating-point results, and/or condition code results) that have not yet been committed to architectural state, and which may serve as the source for certain operands. The various execution units may also maintain architectural integer, floating-point, and condition code state from which operands may be sourced.

Instructions issued from issue unit 230 may proceed to one or more of the illustrated execution units for execution. In one embodiment, each of EXU0 235 and EXU1 240 may be similarly or identically configured to execute certain integer-type instructions defined in the implemented ISA, such as arithmetic, logical, and shift instructions. In the illustrated embodiment, EXU0 235 may be configured to execute integer instructions issued from slot 0, and may also perform address calculation and for load/store instructions executed by LSU 245. EXU1 240 may be configured to execute integer instructions issued from slot 1, as well as branch instructions. In one embodiment, FGU instructions and multicycle integer instructions may be processed as slot 1 instructions that pass through the EXU1 240 pipeline, although some of these instructions may actually execute in other functional units.

In some embodiments, architectural and non-architectural register files may be physically implemented within or near execution units 235-240. It is contemplated that in some embodiments, core 100 may include more or fewer than two integer execution units, and the execution units may or may not be symmetric in functionality. Also, in some embodiments execution units 235-240 may not be bound to specific issue slots, or may be differently bound than just described.

Load store unit 245 may be configured to process data memory references, such as integer and floating-point load and store instructions and other types of memory reference instructions. LSU 245 may include a data cache 250 as well as logic configured to detect data cache misses and to responsively request data from L2 cache 105. In one embodiment, data cache 250 may be configured as a set-associative, write-through cache in which all stores are written to L2 cache 105 regardless of whether they hit in data cache 250. As noted above, the actual computation of addresses for load/store instructions may take place within one of the integer execution units, though in other embodiments, LSU 245 may implement dedicated address generation logic. In some embodiments, LSU 245 may implement an adaptive, history-dependent hardware prefetcher configured to predict and prefetch data that is likely to be used in the future, in order to increase the likelihood that such data will be resident in data cache 250 when it is needed.

In various embodiments, LSU 245 may implement a variety of structures configured to facilitate memory operations. For example, LSU 245 may implement a data TLB to cache virtual data address translations, as well as load and store buffers configured to store issued but not-yet-committed load and store instructions for the purposes of coherency snooping and dependency checking. LSU 245 may include a miss buffer configured to store outstanding loads and stores that cannot yet complete, for example due to cache misses. In one embodiment, LSU 245 may implement a store queue configured to store address and data information for stores that have committed, in order to facilitate load dependency checking. LSU 245 may also include hardware configured to support atomic load-store instructions, memory-related exception detection, and read and write access to special-purpose registers (e.g., control registers).

Floating point/graphics unit 255 may be configured to execute and provide results for certain floating-point and graphics-oriented instructions defined in the implemented ISA. For example, in one embodiment FGU 255 may implement single- and double-precision floating-point arithmetic instructions compliant with the IEEE 754-1985 floating-point standard, such as add, subtract, multiply, divide, and certain transcendental functions. Also, in one embodiment FGU 255 may implement partitioned-arithmetic and graphics-oriented instructions defined by a version of the SPARC® Visual Instruction Set (VIS™) architecture, such as VIS™ 2.0 or VIS™ 3.0. In some embodiments, FGU 255 may implement fused and unfused floating-point multiply-add instructions. Additionally, in one embodiment FGU 255 may implement certain integer instructions such as integer multiply, divide, and population count instructions. Depending on the implementation of FGU 255, some instructions (e.g., some transcendental or extended-precision instructions) or instruction operand or result scenarios (e.g., certain denormal operands or expected results) may be trapped and handled or emulated by software.

In one embodiment, FGU 255 may implement separate execution pipelines for floating-point add/multiply, divide/square root, and graphics operations, while in other embodiments the instructions implemented by FGU 255 may be differently partitioned. In various embodiments, instructions implemented by FGU 255 may be fully pipelined (i.e., FGU 255 may be capable of starting one new instruction per execution cycle), partially pipelined, or may block issue until complete, depending on the instruction type. For example, in one embodiment floating-point add and multiply operations may be fully pipelined, while floating-point divide operations may block other divide/square root operations until completed.

Embodiments of FGU 255 may also be configured to implement hardware cryptographic support. For example, FGU 255 may include logic configured to support encryption/decryption algorithms such as Advanced Encryption Standard (AES), Data Encryption Standard/Triple Data Encryption Standard (DES/3DES), the Kasumi block cipher algorithm, and/or the Camellia block cipher algorithm. FGU 255 may also include logic to implement hash or checksum algorithms such as Secure Hash Algorithm (SHA-1, SHA-256, SHA-384, SHA-512), or Message Digest 5 (MD5). FGU 255 may also be configured to implement modular arithmetic such as modular multiplication, reduction and exponentiation, as well as various types of Galois field operations. In one embodiment, FGU 255 may be configured to utilize the floating-point multiplier array for modular multiplication. In various embodiments, FGU 255 may implement several of the aforementioned algorithms as well as other algorithms not specifically described.

The various cryptographic and modular arithmetic operations provided by FGU 255 may be invoked in different ways for different embodiments. In one embodiment, these features may be implemented via a discrete coprocessor that may be indirectly programmed by software, for example by using a control word queue defined through the use of special registers or memory-mapped registers. In another embodiment, the ISA may be augmented with specific instructions that may allow software to directly perform these operations.

As previously described, instruction and data memory accesses may involve translating virtual addresses to physical addresses. In one embodiment, such translation may occur on a page level of granularity, where a certain number of address bits comprise an offset into a given page of addresses, and the remaining address bits comprise a page number. For example, in an embodiment employing 4 MB pages, a 64-bit virtual address and a 40-bit physical address, 22 address bits (corresponding to 4 MB of address space, and typically the least significant address bits) may constitute the page offset. The remaining 42 bits of the virtual address may correspond to the virtual page number of that address, and the remaining 18 bits of the physical address may correspond to the physical page number of that address. In such an embodiment, virtual to physical address translation may occur by mapping a virtual page number to a particular physical page number, leaving the page offset unmodified.

Such translation mappings may be stored in an ITLB or a DTLB for rapid translation of virtual addresses during lookup of instruction cache 205 or data cache 250. In the event no translation for a given virtual page number is found in the appropriate TLB, memory management unit 270 may be configured to provide a translation. In one embodiment, MMU 270 may be configured to manage one or more translation tables stored in system memory and to traverse such tables (which in some embodiments may be hierarchically organized) in response to a request for an address translation, such as from an ITLB or DTLB miss. (Such a traversal may also be referred to as a page table walk or a hardware table walk.) In some embodiments, if MMU 270 is unable to derive a valid address translation, for example if one of the memory pages including a necessary page table is not resident in physical memory (i.e., a page miss), MMU 270 may be configured to generate a trap to allow a memory management software routine to handle the translation. It is contemplated that in various embodiments, any desirable page size may be employed. Further, in some embodiments multiple page sizes may be concurrently supported.

As noted above, several functional units in the illustrated embodiment of core 100 may be configured to generate off-core memory requests. For example, IFU 200 and LSU 245 each may generate access requests to L2 cache 105 in response to their respective cache misses. Additionally, MMU 270 may be configured to generate memory requests, for example while executing a page table walk. In the illustrated embodiment, L2 interface 265 may be configured to provide a centralized interface to the L2 cache 105 associated with a particular core 100, on behalf of the various functional units that may generate L2 accesses. In one embodiment, L2 interface 265 may be configured to maintain queues of pending L2 requests and to arbitrate among pending requests to determine which request or requests may be conveyed to L2 cache 105 during a given execution cycle. For example, L2 interface 265 may implement a least-recently-used or other algorithm to arbitrate among L2 requestors. In one embodiment, L2 interface 265 may also be configured to receive data returned from L2 cache 105, and to direct such data to the appropriate functional unit (e.g., to data cache 250 for a data cache fill due to miss).

During the course of operation of some embodiments of core 100, exceptional events may occur. For example, an instruction from a given thread that is selected for execution by select unit 210 may not be a valid instruction for the ISA implemented by core 100 (e.g., the instruction may have an illegal opcode), a floating-point instruction may produce a result that requires further processing in software, MMU 270 may not be able to complete a page table walk due to a page miss, a hardware error (such as uncorrectable data corruption in a cache or register file) may be detected, or any of numerous other possible architecturally-defined or implementation-specific exceptional events may occur. In one embodiment, trap logic unit 275 may be configured to manage the handling of such events. For example, TLU 275 may be configured to receive notification of an exceptional event occurring during execution of a particular thread, and to cause execution control of that thread to vector to a supervisor-mode software handler (i.e., a trap handler) corresponding to the detected event. Such handlers may include, for example, an illegal opcode trap handler configured to return an error status indication to an application associated with the trapping thread and possibly terminate the application, a floating-point trap handler configured to fix up an inexact result, etc.

In one embodiment, TLU 275 may be configured to flush all instructions from the trapping thread from any stage of processing within core 100, without disrupting the execution of other, non-trapping threads. In some embodiments, when a specific instruction from a given thread causes a trap (as opposed to a trap-causing condition independent of instruction execution, such as a hardware interrupt request), TLU 275 may implement such traps as precise traps. That is, TLU 275 may ensure that all instructions from the given thread that occur before the trapping instruction (in program order) complete and update architectural state, while no instructions from the given thread that occur after the trapping instruction (in program) order complete or update architectural state.

Additionally, in the absence of exceptions or trap requests, TLU 275 may be configured to initiate and monitor the commitment of working results to architectural state. For example, TLU 275 may include a reorder buffer (ROB) that coordinates transfer of speculative results into architectural state. TLU 275 may also be configured to coordinate thread flushing that results from branch misprediction. For instructions that are not flushed or otherwise cancelled due to mispredictions or exceptions, instruction processing may end when instruction results have been committed.

In various embodiments, any of the units illustrated in FIG. 2 may be implemented as one or more pipeline stages, to form an instruction execution pipeline that begins when thread fetching occurs in IFU 200 and ends with result commitment by TLU 275. Depending on the manner in which the functionality of the various units of FIG. 2 is partitioned and implemented, different units may require different numbers of cycles to complete their portion of instruction processing. In some instances, certain units (e.g., FGU 255) may require a variable number of cycles to complete certain types of operations.

Through the use of dynamic multithreading, in some instances, it is possible for each stage of the instruction pipeline of core 100 to hold an instruction from a different thread in a different stage of execution, in contrast to conventional processor implementations that typically require a pipeline flush when switching between threads or processes. In some embodiments, flushes and stalls due to resource conflicts or other scheduling hazards may cause some pipeline stages to have no instruction during a given cycle. However, in the fine-grained multithreaded processor implementation employed by the illustrated embodiment of core 100, such flushes and stalls may be directed to a single thread in the pipeline, leaving other threads undisturbed. Additionally, even if one thread being processed by core 100 stalls for a significant length of time (for example, due to an L2 cache miss), instructions from another thread may be readily selected for issue, thus increasing overall thread processing throughput.

As described previously, however, the various resources of core 100 that support fine-grained multithreaded execution may also be dynamically reallocated to improve the performance of workloads having fewer numbers of threads. Under these circumstances, some threads may be allocated a larger share of execution resources while other threads are allocated correspondingly fewer resources. Even when fewer threads are sharing comparatively larger shares of execution resources, however, core 100 may still exhibit the flexible, thread-specific flush and stall behavior described above.

### Instruction Support for Snow Cipher

Turning now to FIG. 3, a block diagram of one embodiment of FGU 255 is depicted. As noted above, processor 10 may be configured to provide instruction-level support to perform cryptographic operations including encryption/decryption and/or hashing algorithms. In some embodiments, processor 10 may provide support for cryptographic operations via FGU 255. In other embodiments, processor 10 may be configured to provide support via other logic within processor 10—e.g., execution units 235 and/or 240.

In the illustrated embodiment, FGU 255 includes a Snow engine 310 configured to perform instructions 302 that produce results 312 of various operations of a Snow cipher algorithm. (In some embodiments, Snow engine 310 may be located elsewhere in processor 10.) In one embodiment, Snow engine 310 supports Snow 2.0. In other embodiments, Snow engine 310 may support other implementations such as Snow 1.0, Snow 3G, etc. As will be described in greater detail below, Snow engine 310, in various embodiments, is configured to perform instructions that are defined within the instruction set architecture (ISA) implemented by processor 10, such that processor 10 is configured to provide specific instruction-level support for a Snow cipher. Thus, a user of processor 10 may be able to specify a smaller number of instructions to implement a Snow cipher than would be required for an ISA that lacked Snow cipher instruction-level support.

Accordingly, Snow engine 310 may provide several additional benefits. Usage of Snow engine 310 may result in more compact code and/or faster execution. For example, in some instances, supported instructions may be capable of accelerating performance by almost an order-of-magnitude over standard software implementations. Further, due to the computationally intensive nature of cryptographic processing, these instructions may be of even greater importance when used on cores where pipeline resources are shared by multiple threads. Snow engine 310 may also provide very low latency for small block sizes, allow multiple threads to access Snow hardware concurrently, and/or take advantage of an existing instruction scheduler to optimize performance. Snow engine 310 may handle chaining modes externally for maximum flexibility. In some embodiments, Snow engine 310 may provide non-privileged access to these instructions to ensure that they can be easy leveraged directly by an application or by open-source cryptographic libraries.

In the following discussion, the operation of an embodiment of the Snow cipher is first described. Examples of particular instructions that Snow engine 310 may perform to implement a Snow cipher are then discussed, including code examples that implement such instructions.

### Snow Cipher

Turning now to FIG. 4A, a block diagram of a Snow cipher 400 (which may be supported by Snow engine 310 in some embodiments) is depicted. Snow cipher 400 is one embodiment of a word-oriented stream cipher that enables encryption and decryption of data. During operation, Snow cipher 400 generates a key Z by performing multiple rounds to generate portions of the key referred to as Zₜ. A sender encrypts unencrypted data (referred to as “plaintext”) by performing exclusive-OR (XOR) operations between the portions Zₜ and portions of plaintext to produce encrypted data (referred to as ciphertext). A recipient then decrypts the ciphertext by regenerating Z and performing XOR operations in a similar manner. In the illustrated embodiment, cipher 400 is configured to implement the Snow 2.0 cipher. See “A new version of the stream cipher SNOW.” Cipher 400 generates a Key Z by using a linear-feedback shift register (LFSR) 410 and a finite state machine (FSM) 420.

LFSR 410, in one embodiment, includes sixteen 32-bit entries that store values Sₜ₊₁₅-Sₜ. (As used herein, a “value S” refers to a value in an entry of an LFSR—e.g., the value Sₜ show in FIG. 4A.) In one embodiment, during a round of cipher 400, each value stored in LFSR 410 is shifted to the right and a new value S is stored as the value Sₜ₊₁₅. The value Sₜ is shifted out and used in an XOR operation 430 with a value Fₜ (described more below) to produce a key portion Zₜ.

To generate a new value of Sₜ₊₁₅, cipher 400, in the illustrated embodiment, performs an alpha multiplication 412 and an alpha division 414 (i.e., an alpha-inverse multiplication 414). (As used herein, an “alpha multiplication” refers to a multiplication of a value S and a value α, α being a root of a primitive polynomial of degree 4 over the Galois field (i.e., finite field) F₂⁸. In the Snow 2.0 and 3G ciphers, α is a root of x⁴+β²³x³+β²⁴⁵x²+B⁴⁸x+B²³⁹ as an element of F₂⁸[X], and β is a root of x⁸+x⁷+x⁵+x³+1 as an element of a F₂[X]. As used herein, an “alpha division” refers to a multiplication of a value S and the inverse of the value α.) Cipher 400 then uses the result of alpha multiplication 412 in an XOR operation 416A with the value Sₜ₊₂. The result of XOR operation 416A is then used in an XOR operation 416B with the result of alpha division 414 to produce the next value of Sₜ₊₁₅ (which may be referred to as Sₜ₊₁₆). It is noted that XOR operations 416A and 416B may be performed in a different order since XOR operations are associative. For example, XOR operation 416B may be performed first on a result of alpha multiplication 412 and a result of alpha division 414, and XOR operation 416A may use the result of XOR operation 416B and the value Sₜ₊₂.

FSM 420, in the illustrated embodiment, receives the values Sₜ₊₁₅ and Sₜ₊₅ and generates the value Fₜ. As noted above, Fₜ is used in XOR operation 430 to produce a portion Zₜ of key Z. To generate Fₜ, FSM 420 stores values in registers R1 422A and R2 422B to maintain state. (As used herein, the value R1 refers to a value that is generated from a modular addition. The value R2 refers to a value that is generated from a substitution-box (S-Box) operation described below.) FSM 420 performs a modular addition 424A of the value R1 stored in register 422A and the value Sₜ₊₁₅. FSM 420 then performs an XOR operation 426 of the result of modular addition 424A and the value R2 stored in register 422B to produce Fₜ during a given round.

FSM 420, in illustrated embodiment, generates new values of R1 and R2 (referred to herein as values R1′ and R2′, respectively) based on the previous values stored in registers 422A and 422B and the value Sₜ₊₅ stored in LFSR 410. To generate R1′, FSM 420 performs a modular addition of the value stored in register 422B and the value Sₜ₊₅. To generate R2′, FSM 420 performs an S-Box operation 428 of the value stored in register 422A. (As used herein, a substitution-box (S-Box) operation is an operation that uses a substitution box to map a first set bits in a value to a second set of bits. In Snow 2.0, a value R1 is divided into portions w0, w1, w2, and w3. A Rijndael S-Box is then applied to the portions. The results are then multiplied by a polynomial (x+1)y³+y²+y+xεF₂⁸[y] modulo y⁴+1εF₂⁸[y] to produce a value R1′.) In some embodiments, FSM 420 may include additional registers to store additional values used to generate Fₜ (e.g., as in Snow 3G). These additional values may be generated by performing additional S-Box operations.

In some embodiments, functionality of cipher 400 described above may be implemented by standard instructions that may be provided by a processor's ISA. However, performing cipher 400 using general-purpose ISA instructions may require numerous instructions as well as a substantial number of cycles to execute those instructions, diminishing performance.

As will be described below, in various embodiments, Snow engine 310 may be configured to perform instructions that are defined within an ISA for processor 10 and that accomplish more of the work per instruction than in the case of using general-purpose ISA instructions. In some embodiments, such instructions may be executable to perform operations associated with an LFSR of a Snow cipher. For example, in one embodiment, Snow engine 310 is configured to perform an instruction (referred to herein as a “Snow_Alpha” instruction) that is executable to perform an alpha multiplication (e.g., multiplication 412), an alpha division (e.g., division 414), and an exclusive-OR operation (e.g., XOR operation 416B) using their results. In some embodiments, this instruction is further executable to perform an additional exclusive-OR operation (e.g., XOR operation 416A) using a result of the first exclusive-OR operation and a value S (e.g., Sₜ₊₂) (this version of the instruction may be referred to herein as a “Snow_Alpha3” instruction). In some embodiments, Snow engine 310 may be configured to perform instructions that are executable to perform operations associated with a FSM of a Snow cipher. For example, in one embodiment, Snow engine 310 is configured to perform an instruction (referred to herein as a “Snow_AddXOR” instruction) that is executable to perform a modular addition (e.g., addition 424A) of a value R1 (e.g., in register 422A) and a value S (e.g., Sₜ₊₁₅), and to perform an exclusive-OR operation (e.g., XOR operation 428) on a result of the modular addition and a value R2 (e.g., in register 422B). In one embodiment, Snow engine 310 is configured to perform an instruction (referred to herein as a “Snow_Rstep” instruction) that is executable to perform a substitution-box operation (e.g., S-Box operation 428) on a value R1 to produce a value R2′, and to perform a modular addition (e.g., addition 426A) using a value R2 and a value S(t+5) to produce a value R1′. Such instructions may be usable to generate portions of a stream-cipher key (e.g. Zₜ).

In various embodiments, these instructions may also be used to initialize the state of a Snow cipher such as described next.

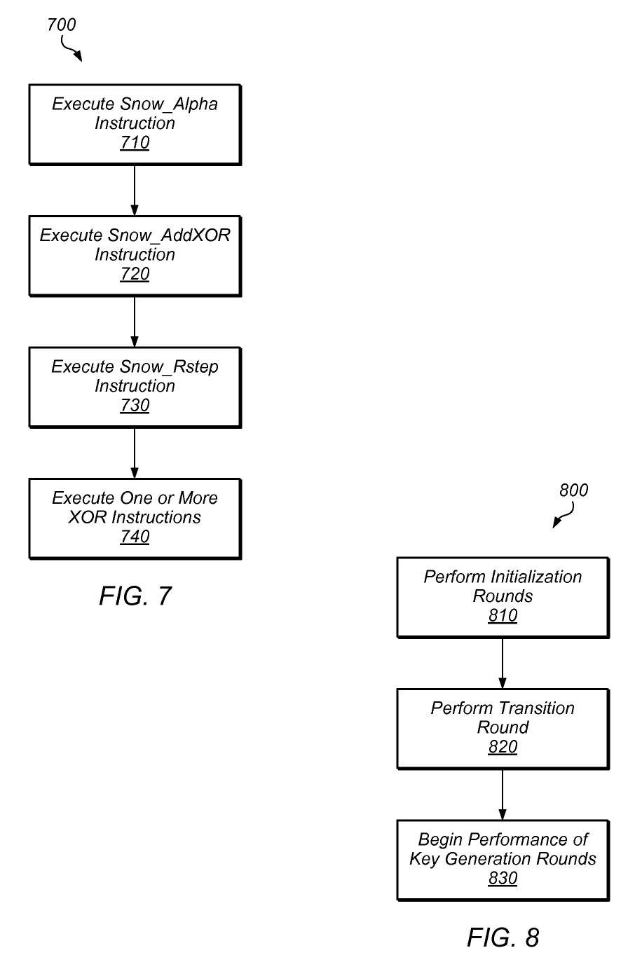

Turning now to FIG. 4B, a block diagram of Snow cipher 400 during an initialization 450 is depicted. In the illustrated embodiment, initialization 450 uses LFSR 410, alpha multiplication 412, alpha division 414, XOR operations 416, FSM 420, and an additional XOR operation 460. In one embodiment, initialization 450 begins by loading LFSR 410 with a secret key and an initialization variable (IV), and loading registers 422 with the value zero. In one embodiment, 32 rounds of cipher 400 are then performed without producing any output. Operation of these rounds may be performed in similar manner as described above, except that the output of FSM 420 Fₜ is used in XOR operation 460 with the result of alpha multiplication 412. The result of XOR operation 460 is then used as an input to XOR operation 414A. Once 32 initialization rounds are performed, in one embodiment, cipher 400 performs a transition round and starts normal operation. A method for initializing a Snow cipher is described below in conjunction with FIG. 8.

### Snow Engine Instruction Support

Turning now to FIG. 5, one embodiment of Snow engine 310 is depicted. In the illustrated embodiment, Snow engine 310 includes Snow_Alpha unit 510, Snow_AddXOR Unit 520, and Snow_Rstep unit 530. As will be described below, in various embodiments, each of these units is configured to perform instructions that implement a portion of a Snow cipher. In some embodiments, Snow engine 310 may provide support for Snow 2.0. In other embodiments, Snow engine 310 may provide support for other versions of Snow ciphers such as Snow 1.0, Snow 3G, etc. It is noted that the partitioning of Snow cipher functionality within Snow engine 310 is merely one example chosen to facilitate exposition. Other configurations of Snow engine 310 are possible and contemplated in which logic may be differently partitioned to implement support for Snow-specific instructions, including instructions that differ from those described below.

Snow_Alpha unit 510, in one embodiment, is configured to perform an instruction (shown as a Snow_Alpha instruction 512) that is executable to perform an alpha multiplication, an alpha division, and an exclusive-OR operation using their results. In one embodiment, Snow_Alpha unit 510 may be configured to directly decode an instruction 512 from opcode bits sent from upstream pipeline stages. In another embodiment, Snow_Alpha unit 510 may be configured to receive an already-decoded or partially-decoded signal indicative of the occurrence of the instruction 512.

To perform a Snow_Alpha instruction 512, Snow_Alpha unit 510, in one embodiment, is configured to receive a set of operands that include the values Sₜ and Sₜ₊₁₁ corresponding to the current round of the cipher. In one embodiment, Snow_Alpha unit 510 includes logic configured to perform an alpha multiplication using Sₜ by shifting bits of Sₜ and performing an XOR operation of the shifted bits and one of a set of stored patterns. In some embodiments, Snow_Alpha unit 510 is configured to perform the alpha multiplication using an α that is a root of x⁴+β²³x³β²⁴⁵x²+B⁴⁸+B²³⁹ as an element of F₂⁸[X]. In one embodiment, Snow_Alpha unit 510 includes logic configured to perform an alpha division using Sₜ₊₁₁, by shifting and masking bits of Sₜ₊₁₁ and performing an XOR operation of the shifted bits and one of a set of stored patterns. In one embodiment, Snow_Alpha unit 510 further includes logic configured to perform an XOR operation on the results of the alpha multiplication and alpha division to produce a result 514 for the Snow_Alpha instruction 512.

In some embodiments, the Snow_Alpha instruction 512 is further executable to perform an additional XOR operation using the result of the initial XOR operation of the alpha-multiplication and alpha-division results. In such embodiments, Snow_Alpha 510 may be further configured to receive a set of operands that additionally includes the value Sₜ₊₂. Snow_Alpha 510 may include additional logic configured to perform an XOR operation of Sₜ₊₂ and the result of the initial XOR operation.

In various embodiments, an instruction 512 may specify operands by identifying one or more architectural registers (e.g., floating-point or integer registers) storing source operands. For example, in one embodiment, an instruction 512 using the mnemonic snow_alpha may be in the form snow_alpha % f00, % f22, % f50 such that % f00 is a floating-point register storing the value Sₜ, % f22 is a floating-point register storing the value Sₜ₊₁₁, and % f50 is a floating-point register used to store the result 514. In another embodiment, an instance of an instruction supported by unit 510 using the mnemonic snow_alpha3 may be in the form snow_alpha3 % f00, % f22, % f04, % f32 such that % f00 is a floating-point register storing the value Sₜ, % f22 is a floating-point register storing the value Sₜ₊₁₁, % f04 is a floating-point register storing the value Sₜ₊₂, and % f32 is a floating-point register used to store the result 514.

In some embodiments, multiple instances of the Snow_Alpha instruction 512 may specify registers in a manner that creates the effect of an LFSR without unit 510 actually including an LFSR. For example, in one embodiment, 17 registers may be used to implement a 16-entry LFSR and temporary storage for one value S. During a first cipher round, the mapping of entries in the LFSR to registers may be as follows:

| | | | | | | | | | | | | | | | | |
|---|---|---|---|---|---|---|---|---|---|---|---|---|---|---|---|---|
| !# | s0 | s1 | s2 | s3 | s4 | s5 | s6 | s7 | s8 | s9 | s10 | s11 | s12 | s13 | s14 | s15 |
| !# | f00 | f02 | f04 | f06 | f08 | f10 | f12 | f14 | f16 | f18 | f20 | f22 | f24 | f26 | f28 | f30 |

In this example, s0-s15 represent Sₜ-Sₜ₊₁₅, and f00-f30 represent register 1-register 16. Register 17 (shown as f32 below) is used to store the newly generated value S. During a second cipher round, the mapping may be as follows:

| | | | | | | | | | | | | | | | | |
|---|---|---|---|---|---|---|---|---|---|---|---|---|---|---|---|---|
| !# | s0 | s1 | s2 | s3 | s4 | s5 | s6 | s7 | s8 | s9 | s10 | s11 | s12 | s13 | s14 | s15 |
| !# | f02 | f04 | f06 | f08 | f10 | f12 | f14 | f16 | f18 | f20 | f22 | f24 | f26 | f28 | f30 | f32 |

Note that instead of shifting values from one register to another, the mapping is merely adjusted to reflect the shift—e.g., the value in f02 now becomes s0. Thus, instructions used in the first round may use the first mapping shown above, and instructions used in the second round may use the second mapping shown.

Snow_AddXOR unit 520, in one embodiment, configured to perform an instruction (shown as a “Snow_AddXOR” instruction 522) that is executable to perform a modular addition of a value R1 and a value S, and to perform an exclusive-OR operation on a result of the modular addition and a value R2. In one embodiment, Snow_AddXOR unit 520 may be configured to directly decode an instruction 520 from opcode bits sent from upstream pipeline stages. In another embodiment, Snow_AddXOR unit 520 may be configured to receive an already-decoded or partially-decoded signal indicative of the occurrence of the instruction.

To perform a Snow_AddXOR instruction 522, Snow_AddXOR unit 520, in one embodiment, is configured to receive a set of operands that include the values Sₜ₊₁₅, and R2 corresponding to the current round of the cipher. In various embodiments, the instruction 522 may specify operands by identifying one or more architectural registers in a similar manner as described above. In some embodiments, the value R1 and the value R2 may be stored in the same register. For example, in one embodiment, an instruction 522 using the mnemonic snow_addxor may be in the form snow_addxor % f30, % f60, % f52 such that % f30 is a floating-point register storing the value Sₜ₊₁₅, % f60 is a floating-point register storing the values R1 and R2, and % f52 is a floating-point register used to store the result 524. In one embodiment, Snow_AddXOR unit 520 includes combinatorial logic configured to perform an addition of the values Sₜ₊₁₅ and R1 modulo 2³². In one embodiment, Snow_AddXOR unit 520 further includes logic configured to perform an XOR operation of the result of the modular addition and the value R2 to produce a value Fₜ. As noted above, the value Fₜ may then be used in an XOR operation with Sₜ to produce a key portion Zₜ.

Snow_Rstep unit 530, in one embodiment, is configured to perform an instruction (shown as a Snow_Rstep instruction 532) that is executable to perform an S-box operation on a value R1 to produce a value R2′, and to perform a modular addition using a value R2 and a value S(t+5) to produce a value R1′. In one embodiment, Snow_Rstep unit 530 may be configured to directly decode the instruction 532 from opcode bits sent from upstream pipeline stages. In another embodiment, Snow_Rstep unit 530 may be configured to receive an already-decoded or partially-decoded signal indicative of the occurrence of the instruction 532.

To perform a Snow_Rstep instruction 532, Snow_Rstep unit 530, in one embodiment, is configured to receive a set of operands that include the values Sₜ₊₅, R1 and R2 corresponding to the current round of the cipher. In various embodiments, the instruction 532 may specify operands by identifying one or more architectural registers in a similar manner as described above. For example, in one embodiment, an instruction 532 using the mnemonic snow_rstep may be in the form snow_rstep % f10, % f60, % f60 such that % f10 is a floating-point register storing the value Sₜ₊₅ and % f60 is a floating-point register storing the values R1 and R2 and used to store the values R1′ and R2′. In one embodiment, Snow_Rstep unit 530 includes logic configured to perform an S-Box operation on the value R1 to produce a value R2′. In some embodiments, the S-Box operation includes using an Rijndael S-Box. In one embodiment, Snow_Rstep unit 530 further includes logic configured to perform a modular addition of the value R2 and the value Sₜ₊₅ to produce a value R1′.

Methods describing the execution of instructions 512, 522, and 532 are described next in conjunction with FIGS. 6A-6C.

Turning now to FIG. 6A, a flow diagram of a method 610 for executing a Snow_Alpha instruction 512 is depicted. Method 610 is one embodiment of a method that may be performed by a processor, such as processor 10, during a round of a Snow cipher, such as Snow 2.0. Method 610 may also be performed during an initialization round of the Snow cipher. In some instances, performing method 610 may provide a significant performance improvement over software implementations of a Snow cipher that rely on general-purpose ISA instructions.

In step 612, processor 10 (e.g., using IFU 200) fetches a Snow_Alpha instruction. As noted above, in one embodiment, the Snow_Alpha instruction may be executable to perform operations associated with an LFSR, which produces a value Sₜ that is usable to produce a key portion Zₜ. In one embodiment, processor 10 sends the instruction to an instruction execution unit (e.g., FGU 255) configured to perform the instruction. For example, in one embodiment, a programmer may specify the instruction within an executable thread of code such that the instruction is fetched, and subsequently issued (e.g., by issue unit 230) to the execution unit.

In step 614, processor 10 (e.g., using unit 510) performs, in response to the fetching of the Snow_Alpha instruction, an alpha multiplication, an alpha division, and an exclusive-OR operation using a result of the alpha multiplication and a result of the alpha division such as described above. In some embodiments, Snow_Alpha unit 510 is configured to perform an alpha multiplication and an alpha division using an α that is a root of x⁴+β²³x³β²⁴⁵x²+B⁴⁸x+B²³⁹ as an element of F₂⁸[X]. In various embodiments, performing these operations may include reading instruction operands (such as the values Sₜ and Sₜ₊₁₁) from a register file, an operand bypass unit, or another operand source, as well as writing a result to working storage or some other suitable destination. In some embodiments, the Snow_Alpha instruction may specify one or more registers that are configured to store the operands and that correspond to positions in an LFSR.

Turning now to FIG. 6B, a flow diagram of a method 620 for executing a Snow_AddXOR instruction 522 is depicted. Method 620 is one embodiment of a method that may be performed by a processor, such as processor 10, during a round of a Snow cipher, such as Snow 2.0. Method 620 may also be performed during an initialization round of the Snow cipher. In some instances, performing method 620 may provide a significant performance improvement over software implementations of a Snow cipher that rely on general-purpose ISA instructions.

In step 622, processor 10 (e.g., using IFU 200) fetches a Snow_AddXOR instruction. As noted above, in one embodiment, the Snow_AddXOR instruction may be executable to perform operations associated with an FSM. In some embodiments, step 622 may be performed in a similar manner as step 612 described above.

In step 624, processor 10 (e.g., using unit 520) performs, in response to fetching of the Snow_AddXOR instruction, a modular addition and an XOR operation, such as described above. In various embodiments, performing these operations may include reading instruction operands (such as the values Sₜ₊₁₅, R1 and R2) from a register file, an operand bypass unit, or another operand source, as well as writing a result to working storage or some other suitable destination. In some embodiments, the Snow_AddXOR instruction may specify a register that is configured to store an operand and that corresponds to a position in an LFSR.

Turning now to FIG. 6C, a flow diagram of a method 630 for executing a Snow_Rstep instruction 532 is depicted. Method 630 is one embodiment of a method that may be performed by a processor, such as processor 10, during a round of a Snow cipher, such as Snow 2.0. Method 630 may also be performed during an initialization round of the Snow cipher. In some instances, performing method 630 may provide a significant performance improvement over software implementations of a Snow cipher that rely on general-purpose ISA instructions.

In step 632, processor 10 (e.g., using IFU 200) fetches a Snow_Rstep instruction. As noted above, in one embodiment, the Snow_Rstep instruction may be executable to perform operations associated with an FSM. In some embodiments, step 632 may be performed in a similar manner as steps 612 and 622 described above.

In step 634, processor 10 (e.g., using unit 530) performs an S-Box operation and a modular addition, such as described above. In some embodiments, the S-Box operation includes using an Rijndael S-Box. In various embodiments, performing these operations may include reading instruction operands (such as the values Sₜ₊₅, R1 and R2) from a register file, an operand bypass unit, or another operand source, as well as writing a result to working storage or some other suitable destination. In some embodiments, the Snow_Rstep instruction may specify a register that is configured to store an operand and that corresponds to a position in an LFSR.

A method that uses instructions 512, 522, and 532 to perform a cipher round is described next.

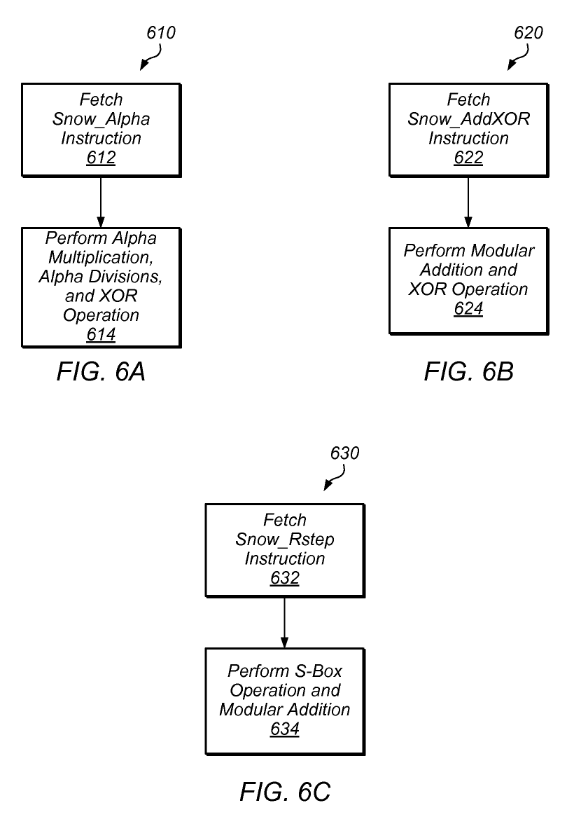

Turning now to FIG. 7, a flow diagram of a method 700 for performing a cipher round is depicted. Method 700 is one embodiment of a method that may be performed by a processor, such as processor 10, which provides instruction-level support for a Snow cipher, such as Snow 2.0. In one embodiment, each cipher round produces a 32-bit running key (i.e., key portion Zₜ), which can be used in an XOR operation with plaintext to produce ciphertext. In some instances, processor 10 is configured to produce the ciphertext with no performance impact to generating the next running key. In some embodiments, steps 710-740 may be performed in a different order than shown.

In step 710, processor 10 executes a Snow_Alpha instruction. In various embodiments, the execution may be performed in a similar manner as described in method 610. In one embodiment, the execution produces a value that is usable in step 740 to produce a value Sₜ₊₁₅ for use in a subsequent cipher round. In another embodiment, the execution produces the value Sₜ₊₁₅. As additional rounds are performed this value, in one embodiment, will be shifted in an LFSR to become a value Sₜ.

In step 720, processor 10 executes a Snow_AddXOR instruction. In various embodiments, the execution may be performed in a similar manner as described in method 620. In one embodiment, the execution uses a value Sₜ₊₁₅ produced in a previous cipher round, along with the values R1 and R2 for the current cipher round to produce a value Fₜ usable in step 740.

In step 730, processor 10 executes a Snow_Rstep instruction. In various embodiments, the execution may be performed in a similar manner as described in method 630. In one embodiment, the execution updates the values R1 and R2 (i.e., creates R1′ and R2′), which may be used in a subsequent cipher round.

In step 740, processor 10 executes one or more XOR instructions. In one embodiment, processor 10 executes two XOR instructions to perform two XOR operations. The first XOR operation may create the value Sₜ₊₁₅ from the value produced in step 710. The second XOR operation may create a portion of a key Zₜ from a value Sₜ created in a previous round and the value Ft created in step 720. In another embodiment, processor 10 executes a single XOR instruction to perform a single XOR operation corresponding to the second XOR described above, and the first XOR operation is performed as part of the execution in step 710.

One example of SPARC assembly language code that implements one embodiment of three cipher rounds (referred to as rk_{—}1, rk_{—}2, and rk_{—}3) using the method of FIG. 7 is as follows:

| | |
|---|---|
| !# | s0 s1 s2 s3 s4 s5 s6 s7 s8 s9 s10 s11 s12 s13 s14 s15 |
| !# | f00 f02 f04 f06 f08 f10 f12 f14 f16 f18 f20 f22 f24 f26 f28 f30 |

| | |
|---|---|
| rk_1: | |
| snow_alpha %f00, %f22, %f50 | !# snow_alpha alpha(s0)\hat{ }alpha_inv(s11) -> temp_sa; |
| snow_addxor %f30, %f60, %f52 | !# snow_addxor (s15 + R1)\hat{ }R2 -> Ft; |
| snow_rstep %f10, %f60, %f60 | !# snow_rstep s5 + R2 -> R1; sbox(R1) -> R2; |
| fxor %f04, %f50, %f32 | !# FXOR_S s2\hat{ }temp_sa -> s15′; |
| fxor %f00, %f52, %f62 | !# FXOR_RK s0\hat{ }Ft -> RK; |

| | |
|---|---|
| !# | s0 s1 s2 s3 s4 s5 s6 s7 s8 s9 s10 s11 s12 s13 s14 s15 |
| !# | f02 f04 f06 f08 f10 f12 f14 f16 f18 f20 f22 f24 f26 f28 f30 f32 |

| | |
|---|---|
| rk_2: | |
| snow_alpha %f02, %f24, %f50 | !# snow_alpha alpha(s0)\hat{ }alpha_inv(s11) -> temp_sa; |
| snow_addxor %f32, %f60, %f52 | !# snow_addxor (s15 + R1)\hat{ }R2 -> Ft; |
| snow_rstep %f12, %f60, %f60 | !# snow_rstep s5 + R2 -> R1; sbox(R1) -> R2; |
| fxor %f06, %f50, %f00 | !# FXOR_S s2\hat{ }temp_sa -> s15′; |
| fxor %f02, %f52, %f62 | !# FXOR_RK s0 \hat{ } Ft -> RK; |

| | |
|---|---|
| !# | s0 s1 s2 s3 s4 s5 s6 s7 s8 s9 s10 s11 s12 s13 s14 s15 |
| !# | f04 f06 f08 f10 f12 f14 f16 f18 f20 f22 f24 f26 f28 f30 f32 f00 |

| | |
|---|---|
| rk_3: | |
| snow_alpha %f04, %f26, %f50 | !# snow_alpha alpha(s0)\hat{ }alpha_inv(s11) -> temp_sa; |
| snow_addxor %f00, %f60, %f52 | !# snow_addxor (s15 + R1)\hat{ }R2 -> Ft; |
| snow_rstep %f14, %f60, %f60 | !# snow_rstep s5 + R2 -> R1; sbox(R1) -> R2; |
| fxor %f08, %f50, %f02 | !# FXOR_S s2 \hat{ } temp_sa -> s15′; |
| fxor %f04, %f52, %f62 | !# FXOR_RK s0 \hat{ } Ft -> RK; |

In this example, note that two XOR operations (referred to as fxor) are performed in a given round and that the snow_alpha instruction has two source operands. As noted above, in some embodiments, the snow_alpha instruction may be executable to perform an additional XOR operation. One example using such an instruction (referred to as snow_alpha3) is as follows:

| | |
|---|---|
| !# | s0 s1 s2 s3 s4 s5 s6 s7 s8 s9 s10 s11 s12 s13 s14 s15 |
| !# | f00 f02 f04 f06 f08 f10 f12 f14 f16 f18 f20 f22 f24 f26 f28 f30 |

| | |
|---|---|
| rk_1: | |
| snow_alpha3 %f00, %f22, %f04, %f32 | !# snow_alpha3 alpha(s0)\hat{ }alpha_inv(s11)\hat{ }s2 -> |
| | s15′; |
| snow_addxor %f30, %f60, %f52 | !# snow_addxor (s15 + R1)\hat{ }R2 -> Ft; |
| snow_rstep %f10, %f60, %f60 | !# snow_rstep s5 + R2 -> R1; sbox(R1) -> R2; |
| fxor %f00, %f52, %f62 | !# FXOR_RK s0\hat{ }Ft -> RK; |

In this second example, note that a single XOR operation is performed in a given round instead of two XOR operations. The instruction snow_alpha3 also has three source operands, one of which is used for the additional XOR operation.

Turning now to FIG. 8, a flow diagram of a method 800 for initializing a cipher is depicted. Method 800 is one embodiment of a method that may be performed by a processor, such as processor 10, which provides instruction-level support for a Snow cipher, such as Snow 2.0.

In step 810, processor 10 performs a set of initialization rounds. During the first initialization round, processor 10, in various embodiments, uses a secret key and an initialization variable (IV) to load registers that implement an LFSR. Processor 10 may also set the values R1 and R2 to zero. In one embodiment, processor 10 then performs 32 initialization rounds before proceeding to step 820. In one embodiment, each round includes an execution of Snow_Alpha, Snow_AddXor, and Snow_Rstep instructions followed by an execution of one or more XOR instruction. In one embodiment, the XOR instructions are performed in a similar manner as in step 740 except that the XOR operation that creates a portion of a key Zₜ is not performed. Instead, an XOR operation of the values Sₜ₊₁₅ and Fₜ may be performed to create a value Sₜ₊₁₅′ that used as Sₜ₊₁₅ in the next initialization round.

One example of SPARC assembly language code that implements one embodiment of an initialization round during step 810 is as follows:

| | |
|---|---|
| !# | s0 s1 s2 s3 s4 s5 s6 s7 s8 s9 s10 s11 s12 s13 s14 s15 |
| !# | f00 f02 f04 f06 f08 f10 f12 f14 f16 f18 f20 f22 f24 f26 f28 f30 |

| | |
|---|---|
| ki_0: | |
| snow_alpha %f00, %f22, %f50 | !# snow_alpha alpha(s0)\hat{ }alpha_inv(s11) -> temp_sa; |
| snow_addxor %f30, %f60, %f52 | !# snow_addxor (s15 + R1)\hat{ }R2 -> Ft; |
| snow_rstep %f10, %f60, %f60 | !# snow_rstep s5 + R2 -> R1; sbox(R1) -> R2; |
| fxor %f04, %f50, %f32 | !# FXOR_S s2\hat{ }temp_sa -> s15′ |
| fxor %f32, %f52, %f32 | !# FXOR_Ki s15′\hat{ }Ft -> s15″ |

In step 820, processor 10 performs a transition round. In one embodiment, the transition round is performed in a similar manner as a key-generation round (described below), but the key portion produced in this round is not used to encrypt data (i.e., it is discarded). After completing the transition round, the cipher may be initialized and ready to generate running keys.

One example of SPARC assembly language code that implements one embodiment of an initialization round during step 820 is as follows:

| | |
|---|---|
| !# | s0 s1 s2 s3 s4 s5 s6 s7 s8 s9 s10 s11 s12 s13 s14 s15 |
| !# | f30 f32 f00 f02 f04 f06 f08 f10 f12 f14 f16 f18 f20 f22 f24 f26 |

| | |
|---|---|
| rk_m1: | |
| snow_alpha %f30, %f18, %f50 | !# snow_alpha alpha(s0)\hat{ }alpha_inv(s11) -> temp_sa; |
| snow_rstep %f06, %f60, %f60 | !# snow_rstep s5 + R2 -> R1; sbox(R1) -> R2; |
| fxor %f00, %f50, %f28 | !# FXOR_S s2\hat{ }temp_sa -> s15′ |

In step 830, processor 10 begins performing key-generation rounds (i.e., begins normal operation). In various embodiments, these rounds are performed in a similar manner as descried in method 700. In one embodiment, processor can generate up to 2⁵⁰ 32-bit running keys.

### Exemplary System Embodiment

As described above, in some embodiments, processor 10 of FIG. 1 may be configured to interface with a number of external devices. One embodiment of a system 900 including processor 10 is illustrated in FIG. 9. In the illustrated embodiment, system 900 includes an instance of processor 10, shown as processor 10a, that is coupled to a system memory 910, a peripheral storage device 920 and a boot device 930. System 900 is coupled to a network 940, which is in turn coupled to another computer system 950. In some embodiments, system 900 may include more than one instance of the devices shown. In various embodiments, system 900 may be configured as a rack-mountable server system, a standalone system, or in any other suitable form factor. In some embodiments, system 900 may be configured as a client system rather than a server system.

In some embodiments, system 900 may be configured as a multiprocessor system, in which processor 10a may optionally be coupled to one or more other instances of processor 10, shown in FIG. 9 as processor 10b. For example, processors 10a-b may be coupled to communicate via their respective coherent processor interfaces 160.

In various embodiments, system memory 910 may comprise any suitable type of system memory as described above, such as FB-DIMM, DDR/DDR2/DDR3/DDR4 SDRAM, RDRAM®, flash memory, and of various types of ROM, etc. System memory 910 may include multiple discrete banks of memory controlled by discrete memory interfaces in embodiments of processor 10 that provide multiple memory interfaces 130. Also, in some embodiments, system memory 910 may include multiple different types of memory.

Peripheral storage device 920, in various embodiments, may include support for magnetic, optical, or solid-state storage media such as hard drives, optical disks, nonvolatile RAM devices, etc. In some embodiments, peripheral storage device 920 may include more complex storage devices such as disk arrays or storage area networks (SANs), which may be coupled to processor 10 via a standard Small Computer System Interface (SCSI), a Fibre Channel interface, a Firewire® (IEEE 1394) interface, or another suitable interface. Additionally, it is contemplated that in other embodiments, any other suitable peripheral devices may be coupled to processor 10, such as multimedia devices, graphics/display devices, standard input/output devices, etc. In one embodiment, peripheral storage device 920 may be coupled to processor 10 via peripheral interface(s) 150 of FIG. 1.

As described previously, in one embodiment boot device 930 may include a device such as an FPGA or ASIC configured to coordinate initialization and boot of processor 10, such as from a power-on reset state. Additionally, in some embodiments boot device 930 may include a secondary computer system configured to allow access to administrative functions such as debug or test modes of processor 10.

Network 940 may include any suitable devices, media and/or protocol for interconnecting computer systems, such as wired or wireless Ethernet, for example. In various embodiments, network 940 may include local area networks (LANs), wide area networks (WANs), telecommunication networks, or other suitable types of networks. In some embodiments, computer system 950 may be similar to or identical in configuration to illustrated system 900, whereas in other embodiments, computer system 950 may be substantially differently configured. For example, computer system 950 may be a server system, a processor-based client system, a stateless “thin” client system, a mobile device, etc. In some embodiments, processor 10 may be configured to communicate with network 940 via network interface(s) 160 of FIG. 1.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A processor, comprising:
an instruction fetch unit configured to fetch instructions defined in an instruction set architecture (ISA) and executable by the processor;
an instruction execution unit configured to receive instructions fetched by the instruction fetch unit, wherein the received instructions include an instance of a first instruction defined within the ISA, wherein the first instruction is executable by the processor to perform an alpha multiplication, an alpha division, and a first exclusive-OR operation using a result of the alpha multiplication and a result of the alpha division.

2. The processor of claim 1, wherein the first instruction is usable to produce a stream-cipher key, and wherein the processor is configured to perform a second exclusive-OR operation of the stream-cipher key and plaintext to produce ciphertext.

3. The processor of claim 1, wherein the processor is configured to perform the alpha multiplication by multiplying a value Sₜ and a value α, wherein the value cc is a root of x⁴+β²³x³β²⁴⁵x²+B⁴⁸x+B²³⁹ as an element of a finite field 2⁸[X].

4. The processor of claim 1, further comprising:
a plurality of registers usable to implement a linear feedback shift register (LFSR);
wherein the instance of the first instruction specifies one of plurality of registers as an input of the alpha multiplication.

5. The processor of claim 1, wherein the received instructions include an instance of a second instruction defined within the ISA, and wherein the second instruction is executable by the processor to perform a modular addition of a value R1 and a value S and to perform a second exclusive-OR operation on a result of the modular addition and a value R2.

6. The processor of claim 5, wherein the received instructions include an instance of a third instruction defined within the ISA, and wherein the third instruction is executable by the processor to perform a substitution-box (S-Box) operation on the value R1 to produce a value R2′, and to perform a modular addition using the value R2 to produce a value R1′.

7. The processor of claim 1, wherein the first instruction is further executable by the processor to perform a second exclusive-OR operation using a result of the first exclusive-OR operation and a value S, and wherein a result of the second exclusive-OR operation is usable to produce a cipher-stream key.

8. A processor, comprising:
an instruction fetch unit configured to fetch instructions defined in an instruction set architecture (ISA) and executable by the processor;
an instruction execution unit configured to receive instructions fetched by the instruction fetch unit, wherein the received instructions include an instance of a first instruction defined within the ISA, wherein the first instruction is executable by the processor to perform a modular addition of a value R1 and a value S, and to perform a first exclusive-OR operation on a result of the modular addition and a value R2, wherein the value R2 is a result of a substitution-box (S-Box) operation.

9. The processor of claim 8, wherein the processor is configured to produce a first portion of a stream-cipher key by performing a second exclusive-OR operation using a result of the first exclusive-OR operation.

10. The processor of claim 9, wherein the stream-cipher key is usable by Snow 2.0.

11. The processor of claim 9, wherein the received instructions include an instance of a second instruction, and wherein the second instruction is executable to perform an S-box operation on the value R1 to produce a value R2′, wherein the value R2′ is usable to produce a second portion of the stream-cipher key.

12. The processor of claim 8, wherein the instance of the first instruction specifies a register configured to store the value S, wherein the register corresponds to a position in a linear feedback shift register.

13. The processor of claim 8, wherein the first instruction is executable as part of an initialization of a stream cipher.

14. The processor of claim 8, wherein the received instructions include an instance of a second instruction, and wherein the second instruction is executable to generate the value S by performing an alpha multiplication.

15. A processor, comprising:
an instruction fetch unit configured to fetch instructions defined in an instruction set architecture (ISA) and executable by the processor;
an instruction execution unit configured to receive instructions fetched by the instruction fetch unit, wherein the received instructions include an instance of a first instruction defined within the ISA, wherein the instruction is executable by the processor to perform a substitution-box (S-Box) operation on a value R1 to produce a value R2′, and to perform a modular addition using a value R2 to produce a value R1′.

16. The processor of claim 15, wherein the processor is configured to use the values R1 and R2 to generate a first portion of a stream-cipher key for a first round of a stream cipher, and wherein the processor is configured to use the values R1′ and R2′ to generate a second portion of the stream-cipher key for a second round of the stream cipher.

17. The processor of claim 15, wherein the modular addition uses a value S, and wherein the instance of the first instruction specifies a register configured to store the value S, and wherein the register corresponds to a position in a linear feedback shift register.

18. The processor of claim 15, wherein the modular addition uses a modulus of 2³².

19. The processor of claim 15, wherein the instance of the first instruction specifies a register that is configured to concurrently store the values R1 and R2.

20. The processor of claim 15, wherein the processor is configured to use a Rijndael S-Box to perform the S-Box operation.

21. A method comprising:
a processor fetching instructions including an instance of a first instruction defined within an instruction set architecture (ISA) of the processor; and
the processor executing the instance of the first instruction to perform a portion of a stream cipher, and wherein executing the instance of the first instruction includes performing an alpha multiplication, an alpha division, and a first exclusive-OR operation using a result of the alpha multiplication and a result of the alpha division.

22. The method of claim 21, wherein the fetched instructions include an instance of a second instruction defined within the ISA, and wherein the method further comprises:
the processor executing the instance of the second instruction to perform a portion of the stream cipher, and wherein executing the instance of the second instruction includes performing a modular addition of a value R1 and a value S, and performing a first exclusive-OR operation on a result of the modular addition and a value R2, wherein the value R2 is a result of a substitution-box (S-Box) operation.

23. The method of claim 22, wherein the fetched instructions include an instance of a second instruction defined within the ISA, and wherein the method further comprises:
the processor executing the instance of the second instruction to perform a portion of the stream cipher, and wherein executing the instance of the second instruction includes performing the substitution-box (S-Box) operation to produce the value R2, and performing a modular addition to produce the value R1.
